(19) United States
(12) Patent Application Publication
(10) Pub. No.: US 2022/0188836 A1
(43) Pub. Date: Jun. 16, 2022

(54) Anti-Money Laundering Blockchain Technology

(71) Applicant: Nicholas Scherling, Aldie, VA (US)

(72) Inventor: Nicholas Scherling, Aldie, VA (US)

(21) Appl. No.: 17/122,067

(22) Filed: Dec. 15, 2020

(51) Int. Cl. G06Q 30/00; G06Q 10/10; H04L 9/06; H04L 9/30

(52) U.S. Cl. CPC G06Q 30/018; G06Q 10/10; H04L 2209/38; H04L 9/30; H04L 9/0618

(57) ABSTRACT

A methodology for consumers and companies utilizing blockchain technology to automate the strict adherence to applicable Anti-Money Laundering (AML) regulations. The users of this software will input personal identification information through a series of questions and attestations that satisfy the “identification” component of relevant AML and Know Your Customer (KYC) regulations when utilizing a risk-based approach. In turn, the software will use the information provided and embed it into the blockchain technology associating it with the creation of public and private keys, thus associating any and all transactions to a user's Personal Identifiable Information (PII) preventing Money Laundering by unknown entities on the blockchain. Once the user finalizes his or her responses to these specified questions, the software will generate a complete documentation package on behalf of the consumer which satisfies the identification component of AML regulations and Financial Action Task Force recommendations. In addition, the documentation package can also act as an auditory trail to be provided to the Financial Industry Regulatory Authority (FINRA), the Securities and Exchange Commission (SEC), the Office of Compliance Inspections and Examinations (OCIE), and other Self-Regulatory Organizations (SRO) and governmental agencies upon request. The result is a blockchain that is fully complaint with Section 354 of the USA PATRIOT Act.

### BACKGROUND OF THE INVENTION

Blockchain technology is most closely associated with cryptocurrencies such as Bitcoin. While the technology is best known as a store of value and monetary exchange vehicle, the blockchain technology is an inherently secure technique that maintains the integrity and provenance of data. Primarily driven by cryptocurrency, the popularity surrounding blockchain continues to grow. Unsurprisingly, as any new monetary exchange systems arises, it creates the potential for fraud and illicit activity using these new systems.

The nature of the cryptocurrency world is one of anonymity. While cryptocurrency exchanges in the United States do require users to register before creating accounts on their systems users are still able to send and receive cryptocurrencies with anyone that has an established cryptocurrency wallet. Users seeking to bypass AML regulations and maintain anonymity are able to locate exchanges in other countries or on the “Dark Web” that don't require or verify user data and as a result circumvent or ignore AML efforts. In many ways, the current system operates like cash, transactions can be conducted between individuals without any exchange or third party and creation of a wallet requires no verified Personal Identifiable Information (PII) or any PII at all. The techniques and software outlined in this patent submission are designed to remedy this situation by embedding PII in the blockchain tied to a user's public and private key. Users that are unwilling to provide this information, and users deemed “high risk”, are not issued a public or private key. Only in the case where compliance requirements are satisfied will a public and private key be issued. Without these keys, no transactions are allowed on the blockchain.

Money laundering is the process used by criminals to disguise the original ownership and control of proceeds derived from criminal activity. Money laundering gives the appearance that illicit proceeds have derived from a legitimate source. AML regulation is designed to thwart money laundering. As a result, legitimate persons and entities must also comply with AML regulation even though the purpose of their activity is not illicit. Techniques and software developed by the named inventor embeds personal identification information and preserves the decentralized public ledger aspects associated with blockchain while assuring compliance with the current federal regulatory framework. This safeguards consumers as well as public and private entities using the named inventor's techniques and software from unintentionally running afoul of federal regulations such as the USA PATRIOT Act, the Bank Secrecy Act, and the Financial Crimes Enforcement Network in their mission to thwart illegal money laundering.

The utilization of the named inventor's software automates and simplifies compliance processes vis-à-vis AML and KYC regulations. The AML blockchain approach outlined in this patent submission incorporates the secure qualities of the blockchain (i.e., fully decentralized databases, resistance to hacking, unauthorized data manipulation, fraud, and censorship) with automation and streamlining that assures users are compliant with the burdensome yet necessary AML and KYC regulations. Further, the named inventor's software will generate necessary compliance documentation to assist users—whether a natural person or legal entity—in having supporting documentation in place thereby evidencing conformity with the Bank Secrecy Act laws. Embedding this information into the blockchain tied to the creation of public and private keys for these purposes is unique and simplifies the complexities of AML regulations, thus making it distinct from other blockchain technologies.

### BRIEF SUMMARY OF THE INVENTION

The named inventor has developed proprietary software and techniques that maintain the attractive attributes of the blockchain, while simultaneously eliminating the risk of potential violations of applicable AML and KYC regulations. The software is designed to elicit and preserve Personal Identifiable Information through a series of simplified questions and attestations that the named inventor derives from federal AML regulatory compliance doctrine on an ongoing basis. An intuitive Graphics User Interface (GUI) systematically guides the user of the software based on responses to relevant questions. Underlying and behind the scenes of the question and response interaction of the user and the software lay regulatory compliance doctrine that must be satisfied in order to successfully navigate the process. At the end of the user's interaction with the software, a complete documentation package is generated on behalf of the consumer that can be provided to applicable Self-Regulatory Organizations (SRO) upon request and can assist in regulatory audits. PII data is then embedded in the blockchain to render it secure and relatively immune to fraudulent activity or accidental manipulation and tied to a user's public and private key.

At its core, the term “blockchain” simply refers to a distributed ledger technology that allows data to be stored globally on thousands of servers, while granting anyone on its network the transparency to view all entries in real-time. One of the most attractive aspects of blockchain technology is decentralized databases that make it nearly impossible for one user or “bad actor” to gain control of the network. In layman's terms, it is not easy to hack.

Despite the potential for fraud, the efficacy and inherent security of the blockchain approach continues to result in growth and confidence in consumer markets. Moreover, the security of the blockchain approach has applicability across a wide range of data security challenges. Especially in a business context, the ability to provide transactional transparency, data provenance, and the ability to create secure, real-time communication networks with partners around the world to support all different types of transactional data speaks to the future of blockchain technology and platforms. Public and private entities involved either directly or indirectly in the digital asset space are required to maintain alignment with AML and KYC standards in order to effectively monitor the risks associated with blockchain technology.

The approach seeking to be patented embeds AML compliant user data directly into the blockchain. Upon successfully providing the necessary information to satisfy the named inventor's risk-based AML approach, a public and private key is issued. If the information is not provided, or if the user is deemed to be a high-risk user, then no key is issued, and no transaction can be initiated. This drives AML compliance and transparency from the exchange directly into the cryptocurrency itself. The result is that all transactions facilitated on the blockchain using the named inventor's software are AML compliant, identifiable, and traceable.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 How Personal Information Is Stored on the Blockchain. The user's Personally Identifying Information is secured with a key, which is a long randomly generated sequence of characters, similar to a password. That key is then encrypted each with the software's public key and the user's own public key and stored on the blockchain. These keys are another set of publicly viewable character sequences, which shows who can unlock the data. This ensures that only the Blockchain owner (which includes, but is not limited to, an entity, foundation, or security owner. This is non-exhaustive) and the user can decrypt this information with either the Blockchain owner or the user's private key. Every public key has a corresponding private key, which is the only way to unlock and read the data.

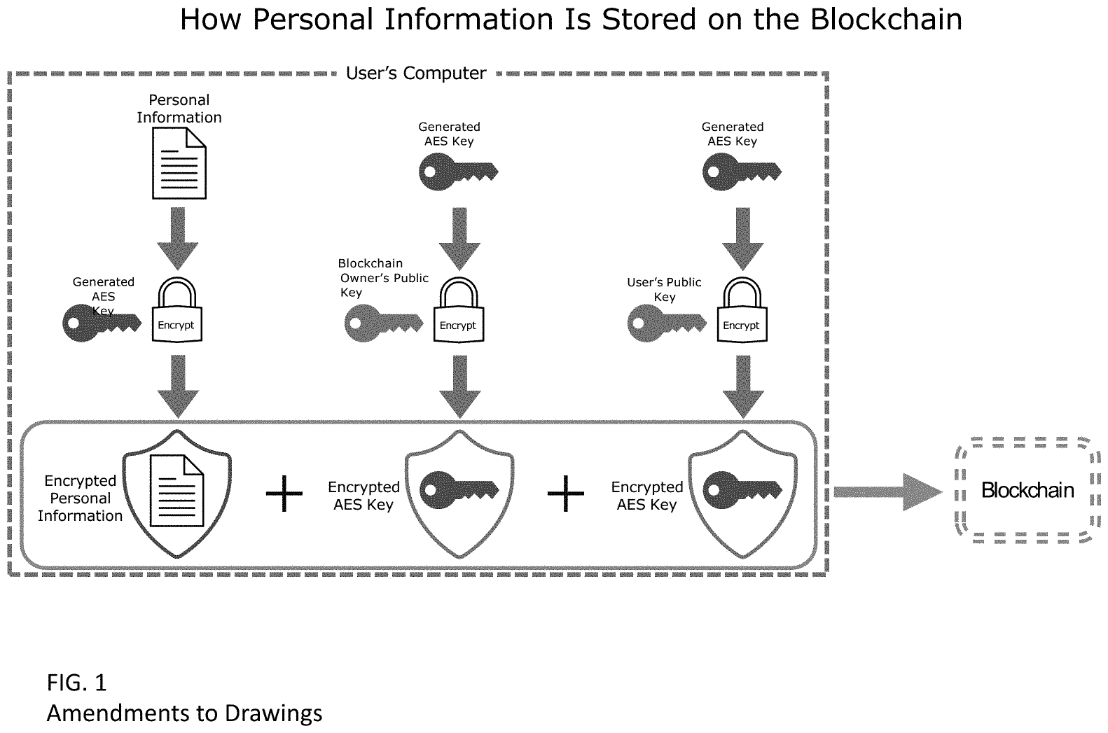

FIG. 2 How Personal Information Is Stored on the Blockchain (Blockchain Details). The encrypted Personally Identifying Information is sent to an entry point to the blockchain network. The information is then distributed across the entire network, verified that there are no red flags or malicious actors sending bad data (referred to as mining), and finally stored on the chain.

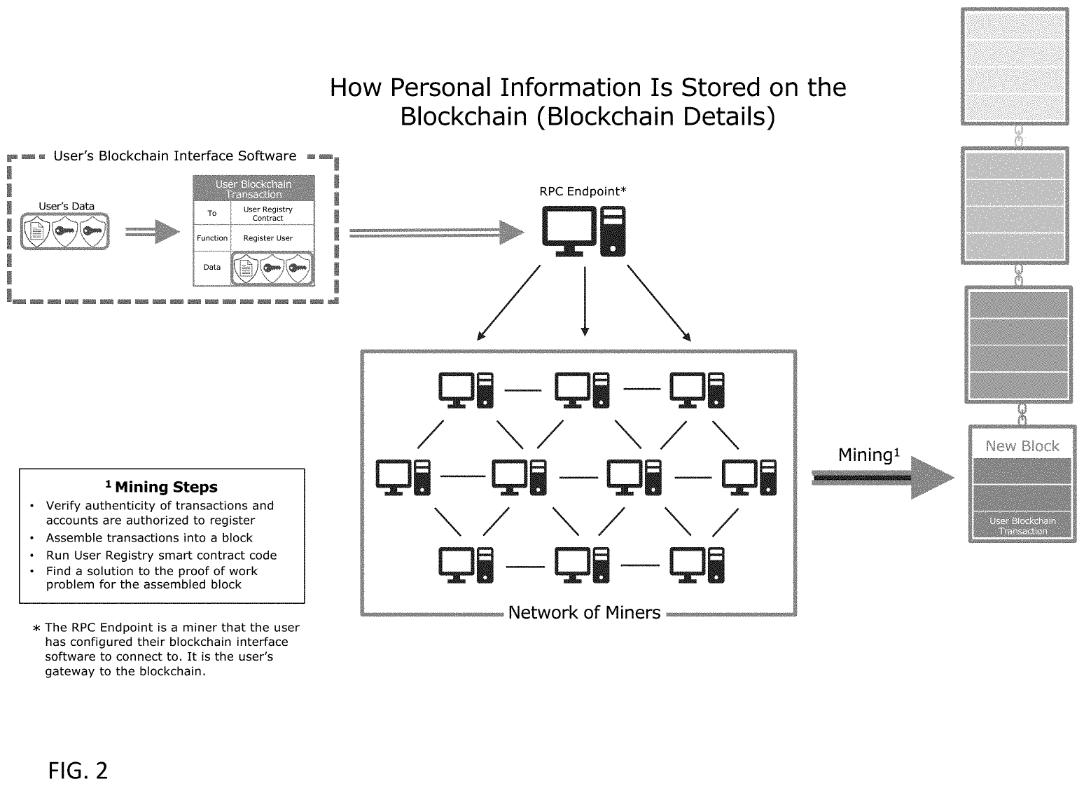

FIG. 3 How Personal Information Is Read From the Blockchain. To obtain the user's Personally Identifying Information from the blockchain, the Blockchain owner or the user decrypt, or unscramble, the key used to secure the data using either the Blockchain owner's or the user's private key, which is similar to a password. The Blockchain owner will then use the obtained key to decrypt the identifying information. No one except the Blockchain owner or the user can decrypt this information. If the user is attempting to update or read their information, then it will be the user who decrypts this information. If the Blockchain owner is providing information to a regulatory authority, then it will be the Blockchain owner who decrypts this information.

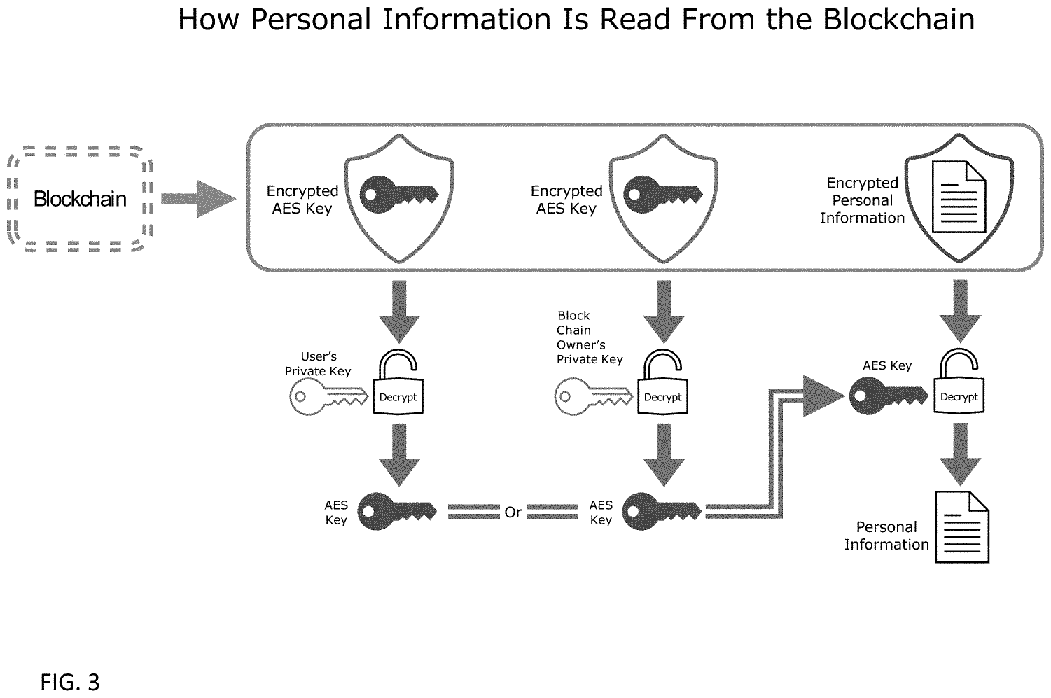

FIG. 4 How the Blockchain Requires Registration to Use. All transactions must be from a registered user. When a new transaction is sent to the blockchain it verifies that the sending address is associated with a registered user. If the address is associated with a registered user, it sends the transaction to be processed. If the address is not associated with a registered user, it then checks to see if this is a new user registration transaction. If it is a new user registration transaction and the user information clears the filter and verification steps in FIG. 5 the information is sent to the blockchain to be processed resulting in a user's information being stored on the blockchain associated with the user's key. If the transaction is not a registration transaction the transaction is rejected.

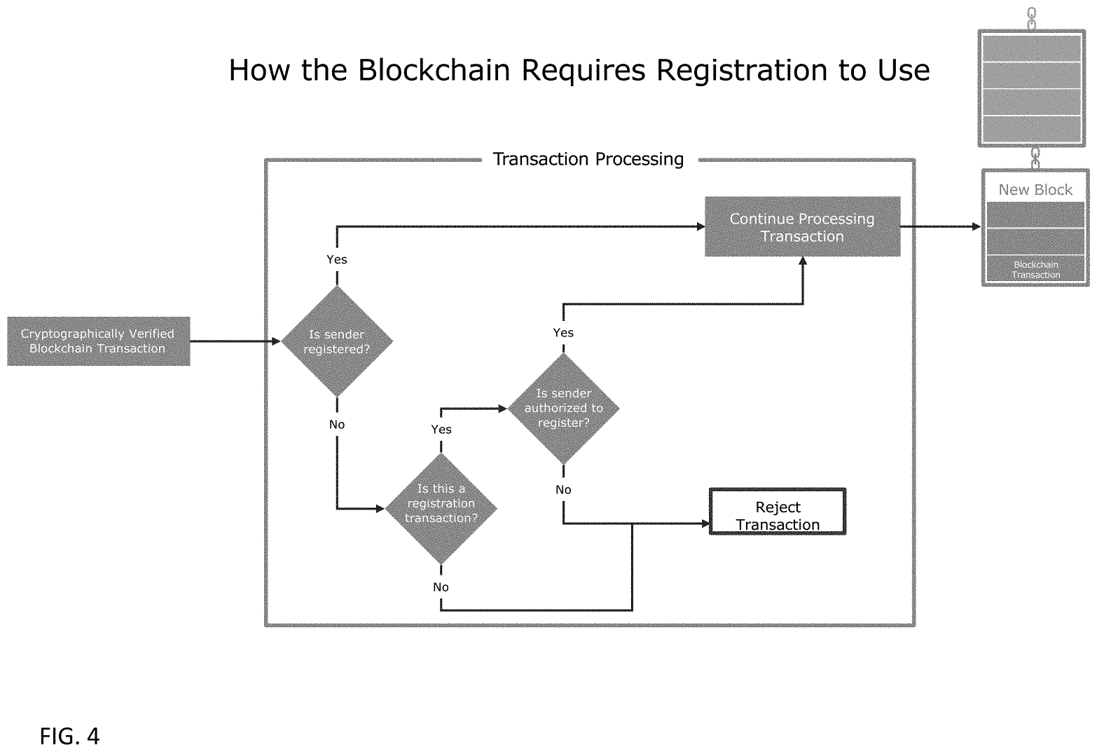

FIG. 5 How the Software Authorizes Unregistered Users To Register. A user who wishes to register must have an established wallet address. A wallet address is a public-private key pair, where users can enter their key into a software that will then track their assets. This software will also sometimes facilitate transactions across the blockchain network using the key as a signature. When a user wishes to register, they visit the website, enter their personal information, and then sign the registration with their public key (address). The blockchain owner then filters and verifies (in this case OFAC and SPAM checks) all the user information before adding it to the blockchain as shown in FIG. 1 and FIG. 2. This allows the blockchain owner to see the user's information when necessary, by decrypting it with the blockchain owner's key.

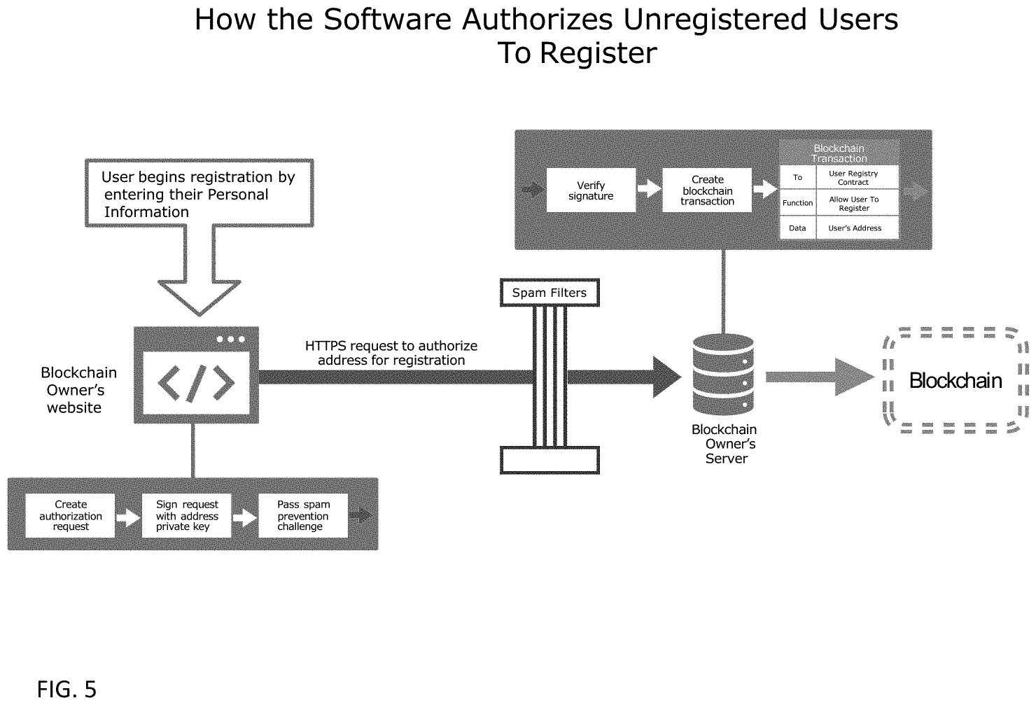

### DETAILED DESCRIPTION OF THE INVENTION

This blockchain technology identifies and complies with AML and KYC regulations immediately at the onset when users begin their registration process. Users of this software will first have to identify if they are registering as an individual or a legal entity. If the user is an individual, then the following information must be provided (this list will be updated as appropriate to comply with future AML requirements):
1. Full Legal Name
2. Date of Birth
3. Country of Residence
4. Full Address (Street, Unit, City, State/Provence, post code)
5. Country of Citizenship
6. Government ID number for citizenship country (i.e., SS # for United States citizens)
7. Email Address
8. IP Address being used to register (displayed on the registration page)
9. Picture of Government issued ID acceptable for identity verification

Alternatively, if the user identifies itself as an entity, then the following information must be provided:
1. Company Name
2. Country they are based in
3. Full Address (Street, Unit, City, State/Provence, post code)
4. Country Issuing Identification Number
5. Company Identification Number
6. Contact Email Address
7. IP Address being used to register (displayed on the registration page)
8. For any “control person” and any beneficial owner (i.e., any individual who owns at least 25% of the entity) following information must also be provided:
   a) Full Legal Name
   b) Date of Birth
   c) Country of Residence
   d) Full Address (Street, Unit, City, State/Provence, post code)
   e) Country of Citizenship
   f) Government ID number for citizenship country (i.e., SSN for United States)
   g) Email Address

For those individuals and/or entities that are not based in the United States, the software will use a risk-based approach in determining whether a user shall be permitted to access its blockchain technology, and if necessary, implement proper control procedures to monitor such user.

Further, while the information collected will help identify the software's users, the software will also use documentary and nondocumentary methods to verify the identity of its users.

After a user has entered all of his or her information and execute an attestation that the information provided is true and complete to the best of their knowledge, their information as specified in the “Data Software Collects” section will be encrypted and will be uploaded via a blockchain transaction, completing their registration. Once on the blockchain anyone can view the encrypted data, but only the patented software and the user will be able to decrypt it and see the user's information.

The encryption and upload occur according to the following procedures:
1. A random AES-256 key is generated
2. The AES-256 key is used to encrypt the user's information
3. The AES-256 key is itself encrypted two separate times using:
   a) The user's public key corresponding to their blockchain address.
   b) public key corresponding to a private key that we own
4. The AES-256 encrypted user data and the two encrypted AES-256 keys are uploaded to the blockchain registration smart contract via a transaction from the user

The decryption occurs according to the following procedures:
1. The user's encrypted data and the encrypted AES-256 keys are downloaded from the blockchain
2. One of the encrypted AES-256 keys is decrypted
   a) If patented software: Its private key is used to decrypt the AES-256 key.
   b) If a user: The user's private key (corresponding to the one they use for the blockchain) is used to decrypt the AES-256 key.
3. The now decrypted AES-256 key is used to decrypt the user's information

1. A blockchain software comprising an automated process to satisfy Anti-Money Laundering regulations.

2. A blockchain software as in claim 1, wherein said automated processes are produced from the responses to a series of questions/fillable user entries developed based on guidance by federal and state regulations.

3. A blockchain software as in claim 2, wherein the responses to said series of questions produce specific Personal Identifiable information that is embedded and preserved within the blockchain software tied/associated with a public and private key.
